(19) United States
(12) Patent Application Publication
(10) Pub. No.: US 2004/0224641 A1
(43) Pub. Date: Nov. 11, 2004

(54) Method for transmitting safety related data

(75) Inventor: Ulrich Sinn, Erlangen (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/788,471

(22) Filed: Mar. 1, 2004

(30) Foreign Application Priority Data
Apr. 14, 2003 (DE) 10317131.2

(51) Int. Cl. H04B 1/38

(52) U.S. Cl. 455/73; 455/115.1

(57) ABSTRACT

A method and associated apparatus for transmitting data (2) between a mobile radio transmitter (1) and a radio receiver (3) of a machine or plant (4). With this method, a first radio link (6) is provided between an operating device and a machine/plant for transmitting safety related information and a second radio link (7) is provided for transmitting non-safety related information.

The following disclosure is based on German Patent Application No. 10317131.2, filed on Apr. 14, 2003, which is incorporated into this application by reference.

### FIELD OF AND BACKGROUND OF THE INVENTION

The invention relates to a method for data transmission between a mobile radio transmitter and a radio receiver of a machine or plant. The invention further relates to a radio transmitter and a radio receiver for carrying out this method.

Mobile radio transmitters typically have a transmitter/receiver unit, i.e., they work with a physical channel. If safety related information is transmitted over this channel together with non-safety related information, there is a risk that the safety related information is blocked by non-safety related information and is therefore transmitted with a delay. Furthermore, radio connections offer less favorable conditions than cable for the transmission of time-critical information, because the information requires a clearly longer time span for transmission.

### OBJECTS OF THE INVENTION

If a radio connection is used for transmitting safety related information, it is therefore necessary to ensure that this information is not blocked by non-safety related information, that the information requires the shortest possible time span for transmission, and that no obsolete information is transmitted.

One object of the invention is to provide a particularly reliable method for data transmission between a mobile control unit radio transmitter and a radio receiver of a machine or plant. A further object of the invention is to provide a radio transmitter and a radio receiver for carrying out such a method.

### SUMMARY OF THE INVENTION

These and other objects are attained by a method for transmitting data between a mobile radio transmitter and a radio receiver of a machine or plant, which method includes: providing a first radio link between the radio transmitter and the radio receiver for transmitting safety related information; and providing a second radio link between the radio transmitter and the radio receiver for transmitting non-safety related information.

The method for data transmission according to the invention provides a first radio link between a radio transmitter and a radio receiver of the machine/plant for transmitting safety related information and a second radio link for transmitting non-safety related information. The use of two separate radio links ensures that safety related information can be transmitted and no blocking or impairment of a transmission channel, e.g., by non-safety related information, can occur. Using a separate radio link for transmitting safety related information improves the reliability of the data transmission.

The first and second radio links are advantageously set up jointly and are operated side by side, in parallel.

According to another advantageous variant of the method, the first radio link for transmitting safety related information is operated with a maximum packet life independently of the second radio link.

In another advantageous variant of the method, the first radio link for transmitting safety related information is operated synchronously to the second radio link.

If the first radio link offers a greater number of data slots than is necessary for the safety related information to be transmitted, duplicates of the safety related information can be transmitted via the first radio link to further increase the reliability of the data transmission. To limit the transmission time, the number of the duplicates to be transmitted can be predefined and limited.

According to yet another variant of the method, duplicates of safety related information can be transmitted until new safety related information is available and/or until the transmitted information has been correctly received. This further improves the transmission reliability.

Duplicates of safety related information received in the radio receiver without error are forwarded and further processed only once. Additional duplicates received without error are deleted.

According to another variant of the method, the first and the second radio link can be set up via a single radio system, to achieve a cost-saving and compact configuration. According to yet another variant of the method, two separate radio systems can be provided, such that even if one radio system fails, e.g., the radio system for transmitting non-safety related information, radio transmission of the safety related information is nonetheless ensured. If one radio system fails, the still functioning radio system can advantageously take over the transmission of the safety related information.

According to yet another variant of the method, safety related information is transmitted via a first radio link using the Bluetooth standard and an SCO link, and the non-safety related information is transmitted via the second radio link using the Bluetooth standard and an ACL link.

The first and second radio links can be set up via a single radio system based on the Bluetooth standard and operated in parallel as an SCO link and an ACL link.

### BRIEF DESCRIPTION OF THE DRAWINGS

The invention will now be described in greater detail, by way of example, with reference to the embodiments depicted in the drawing figures in which:

FIG. 1 is a schematic representation of a data transmission between a radio transmitter and a radio receiver connected to a machine/plant,

FIG. 2 shows a data transmission via a single radio system,

FIG. 3 shows a data transmission via two separate radio systems, and

FIG. 4 shows a data transmission of duplicates of safety related information.

### DETAILED DESCRIPTION OF THE PREFERRED EMBODIMENTS

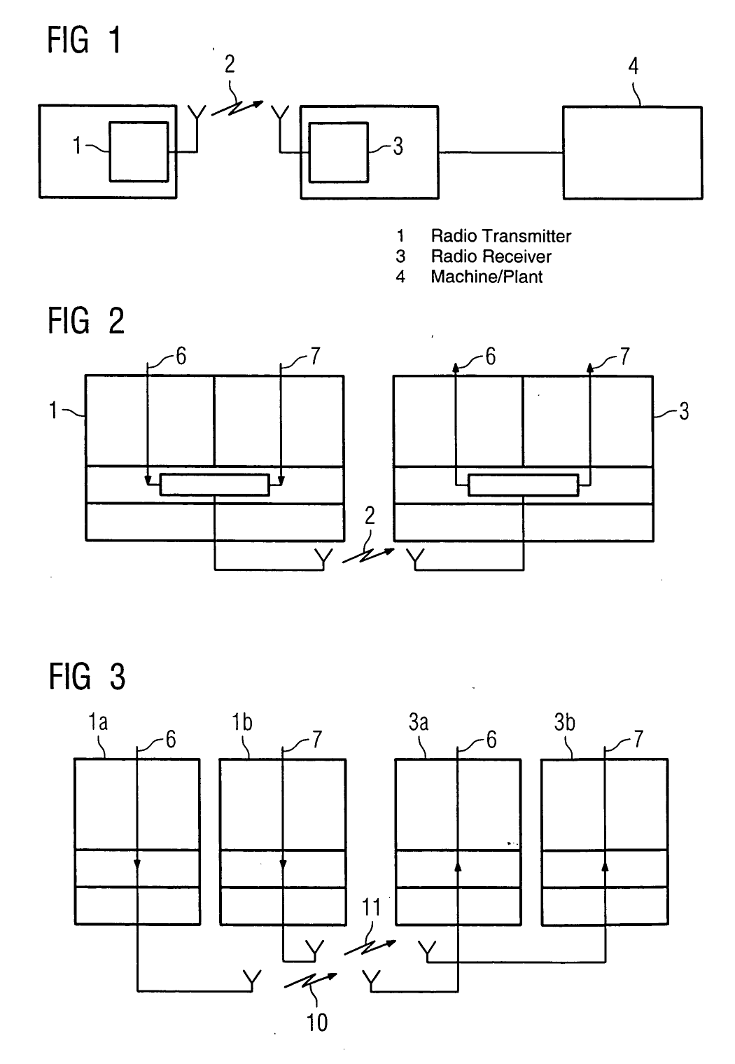

FIG. 1 shows a radio transmitter 1 for transmitting data over a radio path 2 with a radio receiver 3 connected with a machine/plant 4. According to the described method for data transmission, a first and a second radio link are set up via the radio path 2.

In general, each radio transmitter 1 can also be configured as a receiver and each radio receiver 3 can also be configured as a transmitter, to enable bidirectional communication.

According to FIG. 2, the first and second radio link can be set up via a single radio transmitter 1 and a single radio receiver 3 (i.e., a single radio system). Safety related information of the radio transmitter 1 can be transmitted, over the radio path 2, via the first radio link 6 and non-safety related information via the second radio link 7.

FIG. 3 shows a data transmission with separate radio transmitters 1a and 1b and separate radio receivers 3a and 3b (i.e., two separate radio systems). Radio transmitter 1a and radio receiver 3a are used to transmit safety related information of the radio transmitter 1, and radio transmitter 1b and radio receiver 3b are used to transmit non-safety related information via radio paths 10 and 11, respectively.

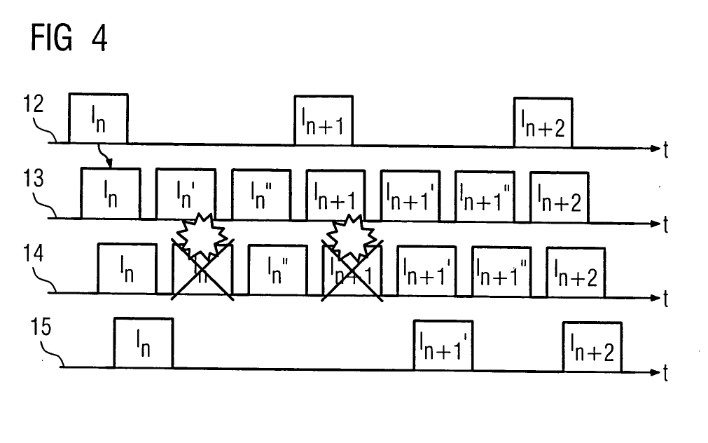

FIG. 4 shows, on an axis 12 (time axis), a generated time sequence of safety related information 1x. This information is transmitted as duplicates 1′ on the axis 13 in the radio transmitter 1 and is received on the axis 14 by the radio receiver 3. Duplicates 1 that have been received without error are deleted in the radio receiver 3 and the non-deleted duplicates 1 are forwarded to the machine/plant 4 on axis 15.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A method for transmitting data between a mobile radio transmitter and a radio receiver of a machine or plant, comprising:
providing a first radio link between the radio transmitter and the radio receiver for transmitting safety related information; and
providing a second radio link between the radio transmitter and the radio receiver for transmitting non-safety related information.

2. The method as claimed in claim 1, wherein the first and the second radio link are set up and operated concurrently.

3. The method as claimed in claim 1, wherein the first radio link is operated with a maximum packet life.

4. The method as claimed in claim 3, wherein the first radio link is operated synchronously with a maximum packet life.

5. The method as claimed in claim 1, further comprising using the first radio link to transmit duplicates of the safety related information.

6. The method as claimed in claim 5, wherein a predefined number of the duplicates is transmitted.

7. The method as claimed in claim 5, wherein the duplicates of the safety related information are transmitted until new safety related information is available.

8. The method as claimed in claim 5, wherein the duplicates of the safety related information are transmitted until the transmitted information has been correctly received.

9. The method as claimed in claim 1, wherein the first and the second radio links are set up via a single radio system.

10. The method as claimed in claim 1, wherein safety related information is transmitted via the SCO link of a radio system using the Bluetooth standard.

11. The method as claimed in claim 1, wherein non-safety related information is transmitted via the ACL link of a radio system using the Bluetooth standard.

12. The method as claimed in claim 11, wherein non-safety related information is transmitted via the ACL link of a radio system using the Bluetooth standard.

13. The method as claimed in claim 12, wherein information is transmitted via a single radio system using the Bluetooth standard.

14. A radio transmitter configured to transmit data to a radio receiver of a machine or plant, comprising:
a first radio link for transmitting safety related information; and
a second radio link for transmitting non-safety related information.

15. A radio receiver of a machine or plant, configured to receive data from a radio transmitter, comprising:
a first radio link for receiving safety related information; and
a second radio link for receiving non-safety related information.
